(19) United States
(12) Patent Application Publication
(10) Pub. No.: US 2003/0141688 A1
(43) Pub. Date: Jul. 31, 2003

(54) Skateboard

(76) Inventor: Ricky L. Lynn, Peoria, AZ (US)

Correspondence Address: Robert A. Parsons, PARSONS & GOLTRY, 340 East Palm Lane, Suite 260, Phoenix, AZ, 85004, US

(21) Appl. No.: 10/060,657

(22) Filed: Jan. 30, 2002

(51) Int. Cl. B62M 1/00

(52) U.S. Cl. 280/87.042

(57) ABSTRACT

Disclosed is a skateboard including base structure attached to and underlying a platform having opposing leading and trailing ends. A first axle is pivoted to the base structure proximate the trailing end and has opposing ends. The opposing ends of the first axle carry opposing parallel first and second inline wheeled frameworks. A second axle is pivoted to the base structure proximate the leading end and has opposing ends. The opposing ends of the second axle carry opposing parallel third and fourth opposing parallel third and fourth inline wheeled frameworks.

### FIELD OF THE INVENTION

This invention relates to skateboards.

### BACKGROUND OF THE INVENTION

Skateboarding is a form of recreation popular among youths, in which a person rides standing balanced on a small board mounted on wheels. Most skateboards are about 0.76 m long and 10 cm wide. Originally, they were made of wood, but later they were also made of aluminum, fiberglass, and plastic. There are two kinds of skateboards: stiff and flexible.

The skateboard first appeared in the early 1960s on paved areas along California beaches as a makeshift diversion for surfboard aficionados when the ocean was flat. Roller skate wheels were simply affixed to miniature surfboards. Skateboards were revived in the middle 1970s after the development of the faster and more maneuverable polyurethane wheel. The craze became worldwide, and skateboard parks were built, providing a variety of slopes and banked surfaces for sudden turns and stunts. Portable ramps were also built to provide a course similar to that for slalom skiing. Accidents to skateboarders led to the creation of special skateboard helmets, knee and elbow pads, and goggles.

Since the advent of the skateboard over four decades ago, significant advances have been made not only in the structure and composition of the boards, but also in the attached wheel assemblies. Present wheel assemblies, while providing adequate maneuverability, are not particularly fast or rugged or stable. In fact, skilled artisans have devoted relatively little time and effort toward improved wheel assemblies designed to increase the speed, maneuverability and stability of skateboards.

Thus, there is as need for a skateboard having a new and improved wheeled configuration that provides exemplary lateral stability, and that is capable of achieving high speeds over a riding surface while providing a high level of stability and efficient maneuverability.

### SUMMARY OF THE INVENTION

The above problems and others are at least partially solved and the above purposes and others realized in an improved skateboard, in accordance with the principle of the invention, the skateboard including base structure attached to and underlying a platform having heel and toe ends. The skate has first and second wheeled trucks. The first truck includes a first axle pivoted to the base structure proximate the heel end and opposing parallel first and second in-line wheeled frameworks. The first axle has opposing ends. The first in-line wheeled framework is secured to one of the opposing ends of the first axle and the second in-line wheeled framework secured to the other of the opposing ends of the first axle. The second wheeled truck includes a second axle pivoted to the base structure proximate the toe end and opposing parallel third and fourth in-line wheeled frameworks. The second axle has opposing ends. The third in-line wheeled framework is secured to one of the opposing ends of the second axle and the fourth in-line wheeled framework is secured to the other of the opposing ends of the second axle. In a preferred embodiment, the first in-line wheeled framework is in-line with the third in-line wheeled framework and the second in-line wheeled framework is inline with the fourth in-line wheeled framework. The first, second, third and fourth in-line wheeled frameworks are substantially identical to one another, in that each includes in-line wheels rotated to an attached coupling.

In another embodiment, a skateboard includes base structure attached to and underlying a platform having heel and toe ends. In this embodiment, a first wheeled truck is attached to the base structure proximate the heel end and a second wheeled truck is attached to the base structure proximate the toe end. One of the first and second wheeled trucks includes a first axle pivoted to the base structure and opposing parallel first and second in-line wheeled frameworks. The first axle has opposing ends. The first in-line wheeled framework is secured to one of the opposing ends of the first axle and the second in-line wheeled framework secured to the other of the opposing ends of the first axle. Preferably, the second wheeled truck includes a second axle pivoted to the base structure and opposing parallel third and fourth in-line wheeled frameworks. The second axle has opposing ends. The third in-line wheeled framework is secured to one of the opposing ends of the second axle and the fourth in-line wheeled framework is secured to the other of the opposing ends of the second axle. In a preferred embodiment, the first in-line wheeled framework is in-line with the third in-line wheeled framework and the second in-line wheeled framework is inline with the fourth in-line wheeled framework. The first, second, third and fourth in-line wheeled frameworks are substantially identical to one another, each including inline wheels rotated to an attached coupling.

Consistent with the foregoing, the invention also contemplates associated methods.

### BRIEF DESCRIPTION OF THE DRAWINGS

Referring to the drawings:

FIG. 1 is a side elevation of a skateboard, in accordance with the principle of the invention, the skateboard including base structure attached to and underlying a platform having heel and toe ends, and wheeled trucks pivoted to the base structure;

FIG. 2 is a bottom plan of the skateboard of FIG. 1; and

FIG. 3 is a fragmented partially exploded perspective view of the skateboard of FIG. 1 illustrating structural features of one of the wheeled trucks.

### DETAILED DESCRIPTION OF A PREFERRED EMBODIMENT

Turning now to the drawings, in which like reference characters indicate corresponding elements throughout the several views, attention is first directed to FIG. 1 in which is seen a skateboard, embodying the principle of the instant invention, generally indicated by the reference character 10 including base structure 11 attached to and underlying a platform 12 having heel and toe ends 13,14, and wheeled trucks 15,16 pivoted to base structure 11. Platform 12 is a short, narrow and relatively flat component constructed of wood, aluminum, fiberglass or the like, as with typical skateboards. And so platform 12 is generally representative of those commonly found in connection with readily available skateboards. Further, those of ordinary skill will readily appreciate that platform 12 can be substantially any platform that is capable of being employed in connection with a skateboard.

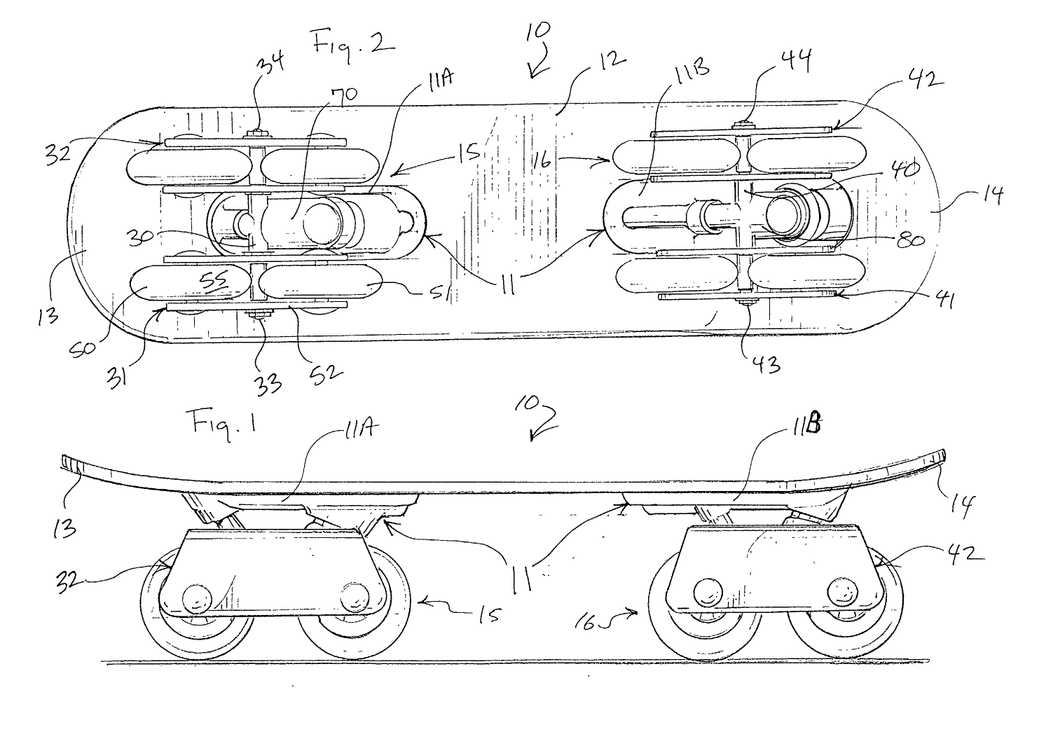

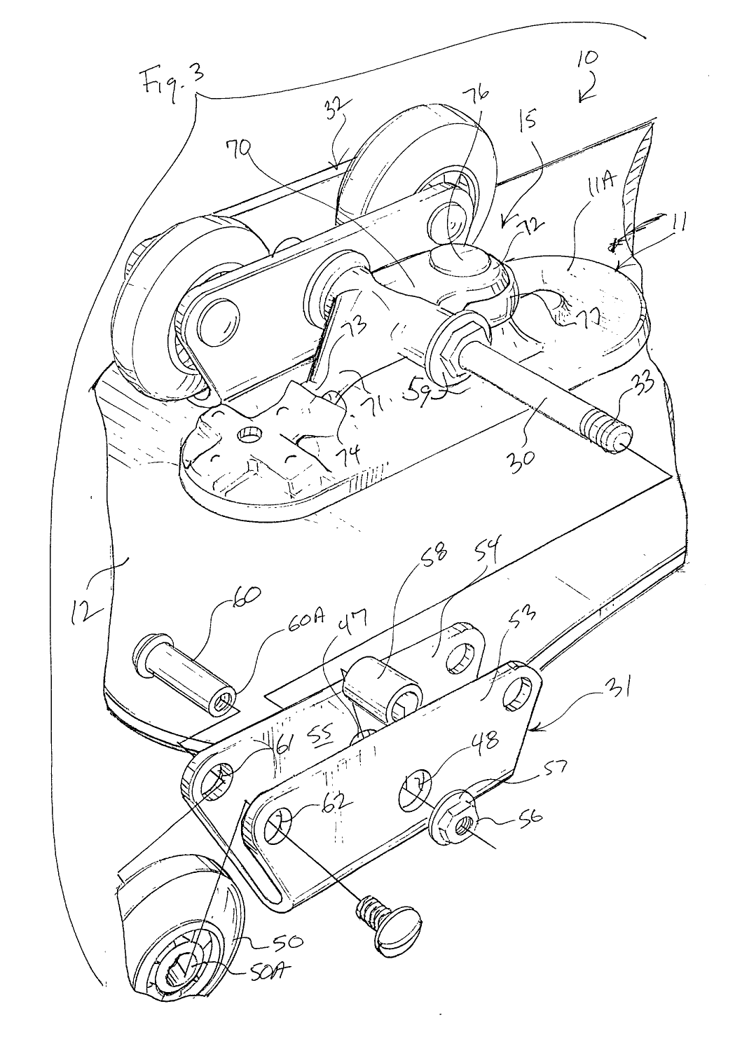

Base structure 11 is attached to and underlies platform 12. Further to FIG. 1, base structure 11 is attached to the underside of platform 12 preferably with screws, rivets, adhesive, etc. Base structure 11 can be integrally formed with platform 12 if desired and this is is secured to end 44. Preferably, framework 31 is in-line with framework 41, and framework 32 is in-line with framework 42. The general composition of trucks 15,16 and the configuration of wheeled frameworks 31,32,41,42 is readily depicted in FIG. 2. Accordingly, skateboard 10 is furnished with opposing parallel in-line sets of wheels, one set being the combination of frameworks 31,41, and the other set being the combination of frameworks 32,42.

The structure and attachment of the opposing parallel in-line wheeled frameworks of trucks 15,16 are identical, and the structure of only one of the in-line wheeled frameworks will be discussed, namely, framework 31. In this regard and considering truck 15, framework 31 includes in-line wheels 50,51 rotated to a coupling 52 attached to end 33 of axle 30. Coupling 52 is fashioned from aluminum, titanium, carbon fiber or other suitably strong and resilient material or combination of materials, and is integrally formed or an assembly of various parts. Preferably, in-line wheels 50,51 are each constructed of polyurethane plastic. Other materials can be used in the construction of wheels 50,51. Although two in-line wheels 50,51 are present in the instant embodiment, more can be employed, which is the case with each of the in-line within the scope of the invention. Base structure 11 may be considered part of, or an extension of, platform 12. Base structure 11 is durable, strong and rigid, and is formed of material having such characteristics such as plastic, metal, wood, etc. In this specific embodiment, base structure 11 consists of opposing base elements 11A,11B, but can, if desired, consist of a single component. Element 11A is attached proximate heel end 13, and element 11B is attached proximate toe end 14. Elements 11A,11B are each integrally formed such as through molding techniques or machining stock material, and yet they each can be constructed of or otherwise made up of a plurality of separate parts. Base structure 11 facilitates the attachment of trucks 15,16 to platform 12 and also provides an underlying support for platform 12.

Looking to FIG. 2, truck 15 includes an axle 30 pivoted to element 11A and opposing parallel in-line wheeled frameworks 31,32. Axle 30 has opposing ends 33,34. Framework 31 is secured to end 33 and framework 32 is secured to end 34. Truck 16 includes an axle 40 pivoted to element 11B proximate toe end 14 and opposing parallel inline wheeled frameworks 41,42. Axle 40 has opposing ends 43,44. Framework 41 is secured to end 43 and framework 42 wheeled frameworks of both trucks 15,16. Regarding FIG. 4, coupling 52 is an elongate bifurcate element, as characterized by opposing generally parallel extremities 53,54 defining a space 55 therebetween. End 33, which is threaded, extends through opposing central openings 47,48 of extremities 54,53, respectively, and is secured with a threaded nut 56. End 33 can be secured to coupling 52 in other ways, such as by welding, a riveted attachment, etc. Preferably, coupling 52 is detachably engaged to axle 30, permitting easy removal thereof for maintenance, repair and replacement. Coupling 52 is attached to axle 30 between nut 56 and an inwardly disposed abutment 59 of axle 30. Preferably, a washer 57 is disposed between nut 56 and extremity 53 and a circular spacer 58 encircles axle 30 at space 55 between extremities 53,54, preventing extremities 53,54 from collapsing inwardly toward one another. This attachment of coupling 52 to axle 30 permits coupling 52 to pivot about axle 30. Wheels 50,51 are rotated at either end of coupling on either side of axle 30 and are disposed at space 55. Considering the attachment of wheel 50, an internally threaded end 60A of a headed axle 60 extends through opposing openings 61,62 through extremities 54,53, respectively, at one end of coupling 52, and is secured with a screw 63. End 60A can be secured to coupling 52 in other ways, such as by welding, a riveted attachment, etc. Preferably, wheel 50 is detachably engaged to coupling 52, permitting easy removal thereof for maintenance, repair and replacement. That portion of axle 60 between extremities 53,54 is disposed through a hub 50A of wheel 50 and wheel 50 is capable of rotating about axle 60. The attachment of wheel 51 to the other end of coupling 52 is identical to the attachment of wheel 50 and will not be discussed. FIG. 3 illustrates framework 31 as it would appear assembled and detached from axle 30. Those having regard for the art will readily appreciate that wheels 50,51 can be rotated to coupling 52 in other ways. Also, although coupling 52 is a preferred structure for facilitating the inline attachment of wheels 50,51, those having regard for the art will readily appreciate that coupling 52 can take on other structural forms such as a single, non-bifurcated element, and wheels 50,51 may be secured for rotation in an inline condition in other ways, consistent with the teachings of the invention.

Axles 30,40 are carried by fixtures 70,80, respectively, which are pivoted to elements 11A,11B, respectively. Fixture 70 is pivoted proximate heel end 13 and fixture 80 is pivoted proximate toe end 14. The structure and attachment of fixtures 70,80 are identical, and the details of only one will be discussed, namely, fixture 70. Considering truck 15 and FIG. 5, fixture 70 is a body having opposing ends 71,72. End 71 carries a ball 73, which is disposed in a socket 74 of element 11A, and the positioning of ball 73 and socket 74 is reversible. Ball 73 is fitted within and held by socket 74, and yet is capable of rotating and pivoting within socket 74 as with a conventional ball and socket attachment. End 72 is pivoted to base structure 11 and can be attached in much the same way as end 71. However, in this embodiment, a headed connecting element 76 extends through end 72 and secures base structure 11, such as threadably or by other suitable connecting means. End 72 is capable of pivoting and moving relative to element 76. Element 76 is rigidly attached. A resilient bumper 77 encircles a portion of element 76 between end 72 and element 11A and is captured between end 72 and element 11A. Bumper 77 is made of durable rubber or other elastomer, permitting end 72 to pivot and providing shock absorption. Axle 30 is attached to fixture 70 and extends outwardly from either side thereof. Axle 30 is considered part of fixture 70. Axle and fixture can be an assembly of various parts. With the exception of element 76, fixture 70 and axle 30 can be integrally formed, such as by casting or machining from aluminum, steel, carbon fiber or other suitably strong, resilient and substantially rigid material or combination of materials.

The opposing parallel sets of in-line wheels, one set being the wheels frameworks 31,41 and the other being the wheels of frameworks 32,42, provide lateral stability for skateboard 10 and permit skateboard to advance smoothly over a riding surface while providing exemplary stability at high speeds. By shifting weight to the left and to the right, the pivoting capability of trucks 15,16 permits a user to turn to the left and to the right, while allowing the wheels of trucks 15,16 to remain in contact with the riding surface.

The present invention is described above with reference to a preferred embodiment. However, those skilled in the art will recognize that changes and modifications may be made to the described embodiment without departing from the nature and scope of the invention. For instance, the wheels of a conventional skateboard of the type having opposing front and rear axles with four wheels attached thereto in a rectangular orientation, can be detached and replaced with the inline wheeled frameworks of the invention, essentially converting a conventional four wheeled skateboard into a skateboard having opposing parallel inline wheels, in accordance with the invention. Various other changes and modifications to the embodiment herein chosen for purposes of illustration will readily occur to those skilled in the art. To the extent that such modifications and variations do not depart from the spirit of the invention, they are intended to be included within the scope thereof, as assessed by a reasonable and fair interpretation of the ensuing claims.

Having fully described the invention in such clear and concise terms as to enable those skilled in the art to understand and practice the same, the invention claimed is:

1. Apparatus comprising:
base structure attached to and underlying a platform having leading and trailing ends;
a first truck comprising:
a first axle pivoted to the base structure proximate the trailing end and having opposing ends, and
opposing parallel first and second inline wheeled frameworks, the first inline wheeled framework secured to one of the opposing ends of the first axle and the second inline wheeled framework secured to the other of the opposing ends of the first axle; and
a second truck comprising:
a second axle pivoted to the base structure proximate the leading end and having opposing ends, and
opposing parallel third and fourth inline wheeled frameworks, the third inline wheeled framework secured to one of the opposing ends of the second axle and the fourth inline wheeled framework secured to the other of the opposing ends of the second.

2. Apparatus of claim 1, wherein the first inline wheeled framework is inline with the third inline wheeled framework.

3. Apparatus of claim 1, wherein the second inline wheeled framework is inline with the fourth inline wheeled framework.

4. Apparatus of claim 1, wherein the first inline wheeled framework comprises:
a coupling secured to the one of the opposing ends of the first axle; and
inline wheels rotated to the coupling.

5. Apparatus of claim 1, wherein the second inline wheeled framework comprises:
a coupling secured to the other of the opposing ends of the first axle; and
inline wheels rotated to the coupling.

6. Apparatus of claim 1, wherein the third inline wheeled framework comprises:
a coupling secured to the one of the opposing ends of the second axle; and
inline wheels rotated to the coupling.

7. Apparatus of claim 1, wherein the fourth inline wheeled framework comprises:
a coupling secured to the other of the opposing ends of the second axle; and
inline wheels rotated to the coupling.

8. Apparatus comprising:
base structure attached to and underlying a platform having trailing and leading ends;
a first wheeled truck attached to the base structure proximate the trailing end and a second wheeled truck attached to the base structure proximate the leading end, one of the first and second wheeled trucks comprising:
a first axle pivoted to the base structure proximate the trailing end and having opposing ends, and
opposing parallel first and second inline wheeled frameworks, the first inline wheeled framework secured to one of the opposing ends of the first axle and the second inline wheeled framework secured to the other of the opposing ends of the first axle.

9. Apparatus of claim 8, the other of the first and second wheeled trucks comprising:
a second axle pivoted to the base structure proximate the leading end and having opposing ends, and
opposing parallel third and fourth inline wheeled frameworks, the third inline wheeled framework secured to one of the opposing ends of the second axle and the fourth inline wheeled framework secured to the other of the opposing ends of the second.

10. Apparatus of claim 9, wherein the first inline wheeled framework is inline with the third inline wheeled framework.

11. Apparatus of claim 9, wherein the second inline wheeled framework is inline with the fourth inline wheeled framework.

12. Apparatus of claim 8, wherein the first inline wheeled framework comprises:
a coupling secured to the one of the opposing ends of the first axle; and
inline wheels rotated to the coupling.

13. Apparatus of claim 8, wherein the second inline wheeled framework comprises:
a coupling secured to the other of the opposing ends of the first axle; and
inline wheels rotated to the coupling.

14. Apparatus of claim 9, wherein the third inline wheeled framework comprises:
a coupling secured to the one of the opposing ends of the second axle; and
inline wheels rotated to the coupling.

15. Apparatus of claim 9, wherein the fourth inline wheeled framework comprises:
a coupling secured to the other of the opposing ends of the second axle; and
inline wheels rotated to the coupling.

16. A method comprising steps of:
providing base structure attached to and underlying a platform having trailing and leading ends;
providing a first truck comprising:
a first axle having opposing ends, and
opposing parallel first and second inline wheeled frameworks, the first inline wheeled framework secured to one of the opposing ends of the first axle and the second inline wheeled framework secured to the other of the opposing ends of the first axle;
providing a second truck comprising:
a second axle having opposing ends, and
opposing parallel third and fourth inline wheeled frameworks, the third inline wheeled framework secured to one of the opposing ends of the second axle and the fourth inline wheeled framework secured to the other of the opposing ends of the second;
pivoting the first axle to the base structure proximate the trailing end; and
pivoting the second axle to the base structure proximate the leading end;
wherein the first inline wheeled framework is inline with the third inline wheeled framework and the second inline wheeled framework is inline with the fourth inline wheeled framework.

17. The method of claim 16, wherein the first inline wheeled framework comprises:
a coupling secured to the one of the opposing ends of the first axle; and
inline wheels rotated to the coupling.

18. The method of claim 16, wherein the second inline wheeled framework comprises:
a coupling secured to the other of the opposing ends of the first axle; and
inline wheels rotated to the coupling.

19. The method of claim 16, wherein the third inline wheeled framework comprises:
a coupling secured to the one of the opposing ends of the second axle; and
inline wheels rotated to the coupling.

20. The method of claim 1, wherein the fourth inline wheeled framework comprises:
a coupling secured to the other of the opposing ends of the second axle; and
inline wheels rotated to the coupling.
